(19) United States
(12) Patent Application Publication
(10) Pub. No.: US 2004/0244565 A1
(43) Pub. Date: Dec. 9, 2004

(54) METHOD OF CREATING MUSIC FILE WITH MAIN MELODY AND ACCOMPANIMENT

(76) Inventors: Wen-Ni Cheng, Taipei City (TW); Chun-Bin Kuo, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/250,141

(22) Filed: Jun. 6, 2003

(51) Int. Cl. G10H 1/36; G10H 7/00

(52) U.S. Cl. 84/610

(57) ABSTRACT

A method of creating a music file comprising a plurality of tracks to be played simultaneously when the music file is played. The method includes creating a main melody track by selecting a respective pitch and duration of a plurality of notes, selecting a style of accompaniment music, retrieving accompaniment tracks for the selected style of accompaniment music from a memory, and combining the main melody track and the accompaniment tracks to create the music file.

### BACKGROUND OF INVENTION

1. Field of the Invention

The present invention relates to creating music files with multiple tracks, and more specifically, to a method for creating music files containing a main melody and an accompaniment.

2. Description of the Prior Art

With the popularity of electronic devices such as cellular phones, users enjoy personalizing their electronic devices with unique songs or tunes. One popular format for creating music files is a Musical Instrument Digital Interface (MIDI) file. Each MIDI file can contain multiple tracks, and each track may contain music for a different instrument. Often one track of the MIDI file is used for storing a main melody and other tracks are used for storing an accompaniment to the main melody.

Please refer to FIG. 1. FIG. 1 is a diagram showing a basic structure of a MIDI file 30 according to the prior art. The MIDI file 30 is composed of a series of bytes of data, each represented in hexadecimal format in FIG. 1. The MIDI file 30 shown in FIG. 1 contains a file header 32, a first track 36, a second track 38, and a third track 40. The file header 32 includes a track number indicator 34 for indicating a total number of tracks included in the MIDI file 30. In this case, the track number indicator 34 contains a value of “3” since there are three tracks. Each of the tracks 36, 38, and 40 can be used for storing the notes of a different instrument, so the MIDI file 30 shown in FIG. 1 may contain music for three different instruments. The file header 32 also contains a quarter note tick indicator 35 for indicating how many clock ticks a quarter note receives. In this case, 78 (measured in hexadecimal; equal to 120 decimal) clock ticks will be equal to the duration of a quarter note. In the example shown in FIG. 1, the first track 36 is used for storing,text and other information. The first track 36 contains a tempo indicator 37 for indicating the duration of a quarter note. The tempo indicator 37 contains six bytes. The first three bytes “FF 51 03” make up an event type indicator. The event type indicator shows that the following three bytes “09 27 C0” (equal to 600,000 decimal) is how many microseconds the duration of a quarter note should be. In this case, the duration of each quarter note will be 0.6 seconds.

The second track 38 and the third track 40 of the MIDI file 30 are examples of two different music tracks. For instance, the second track 38 could represent a main melody and the third track 40 could represent an accompaniment track. Additional accompaniment tracks could also be added to the MIDI file 30, according to the wishes of the user.

Unfortunately, the prior art method of creating the MIDI file 30 is a long and tedious process. The user has to create individual notes not only for the main melody track, but also for each additional accompaniment track. Not many people have the musical knowledge necessary to compose a main melody and an acceptable group of accompaniment tracks. In addition, those who are capable of composing may feel overwhelmed by the amount of time needed for creating many tracks, and may give up before completion.

### SUMMARY OF INVENTION

It is therefore a primary objective of the claimed invention to provide a method for creating a main melody and accompaniment tracks in a music file in order to solve the above-mentioned problems.

According to the claimed invention, a method of creating a music file comprising a plurality of tracks to be played simultaneously when the music file is played is introduced. The method includes creating a main melody track by selecting a respective pitch and duration of a plurality of notes, selecting a style of accompaniment music, retrieving accompaniment tracks for the selected style of accompaniment music from a memory, and combining the main melody track and the accompaniment tracks to create the music file.

It is an advantage of the claimed invention that users can create a MIDI file with a main melody and accompaniment by simply editing the main melody and selecting a style of accompaniment music. This allows users to create their own songs quickly and easily, and no significant knowledge of music is required of the user.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram showing a basic structure of a MIDI file according to the prior art.

FIG. 2 is a diagram illustrating a main melody entered by a user according to the present invention.

FIG. 3 is a detailed diagram of a second track of the MIDI file shown in FIG. 1.

FIG. 4 is a chart showing timing of each event in the second track.

FIG. 5 is a diagram illustrating the main melody of FIG. 2 being divided into measures.

FIG. 6 is a chart of an event buffer showing all note-on events shown in FIG. 4.

FIG. 7 illustrates assigning keys to measures of the main melody for changing a key of the accompaniment.

FIG. 8 illustrates shifting a key of the accompaniment according to the present invention.

FIG. 9 is a diagram of shifting the key of accompaniment tracks according to the present invention.

FIG. 10 is a chart illustrating the offsets of different keys from the key of C.

FIG. 11 is a flowchart illustrating creating the MIDI file according to the present invention method.

FIG. 12 is a flowchart further illustrating calculating the total number of measures in the main melody (step 150 in the flowchart of FIG. 11) according to the present invention method.

FIG. 13 is a flowchart further illustrating combining the main melody with accompaniment tracks (step 200 in the flowchart of FIG. 11) according to the present invention method.

### DETAILED DESCRIPTION

The present invention simplifies the process of creating a MIDI file by automatically adding accompaniment tracks to a main melody track created by the user. The user may music editing software on a cellular phone or computer, for example, to create the MIDI files according to the present invention.

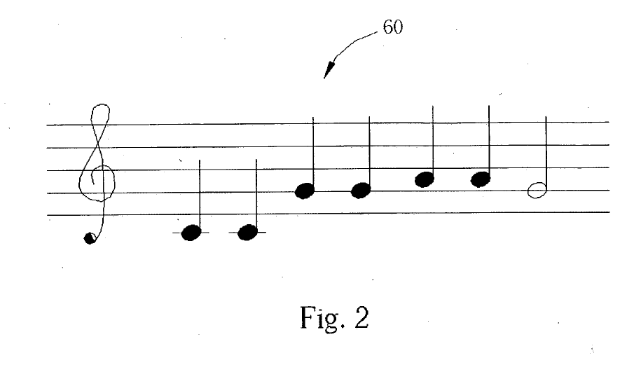

Please refer to FIG. 2. FIG. 2 is a diagram illustrating a main melody 60 entered by a user according to the present invention. FIG. 2 shows the first seven notes of the children's, song “Twinkle, Twinkle Little Star” as an example for the main melody 60. For creating the main melody 60, a user would be presented with an interface allowing the user to select a type of note (such as a whole note, half note, quarter note, etc.) and a pitch of the note (such as A, C, G, etc.). The user could add notes one note at a time until the main melody 60 shown in FIG. 2 is complete. Once the main melody 60 is entered, the main melody 60 can then be converted into a standard MIDI track format.

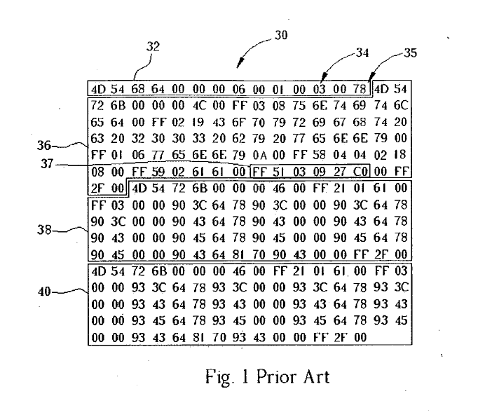

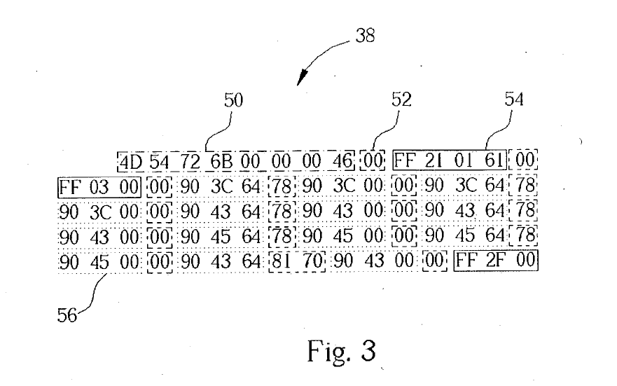

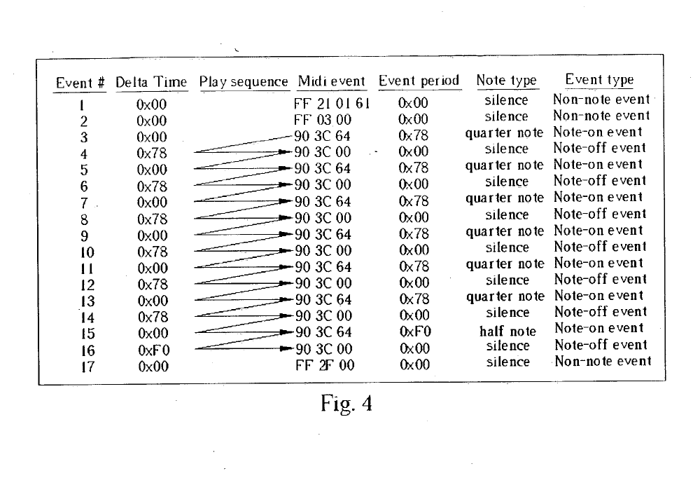

Please refer back to FIG. 1. The MIDI file 30 shown in FIG. 1 contains the first track 36, the second track 38, and the third track 40. For showing how the main melody 60 can be converted into a MIDI track of the MIDI file 30, the second track 38 will be used as an example. Please refer to FIG. 3 and FIG. 4. FIG. 3 is a detailed diagram of the second track 38 of the MIDI file 30 shown in FIG. 1. FIG. 4 is a chart showing timing of each event in the second track 38. Suppose that the second track 38 contains the main melody 60 created by the user. The present invention first involves analyzing the main melody 60 for creating the second track 38 based on the main melody 60. The second track 38 contains a track header 50, a plurality of delta times 52, a plurality of non-note events 54, and a plurality of note-events 56. The delta time 52 is placed before each non-note event 54 and note-event 56 for indicating a period of elapsed time before that event. Since the non-note events 54 do not play any notes in the second track 38, the delta time 52 before each non-note event 54 is equal to “00”. The delta time 52 is varied to change the duration of notes that are specified in the note-events 56. For instance, each quarter note Would have a delta time 52 of 78 (measured in hexadecimal; equal to 120 decimal) clock ticks.

All of the non-note events 54 and note-events 56 are shown in rows of FIG. 4. Seven columns in FIG. 4 show an event number given for reference, the delta time 52 value, a play sequence indicator, the byte representation of the event, a period of the event, a type of note played, and the event type. The delta time 52 value shows the amount of time that elapses between the previous event and the current event. The event period shows how long each event is valid for. Three different event types are shown in FIG. 4. The non-note events 54 do not affect audible notes, the note-on events are the start of new notes, and the note-off events are the endings of notes.

To further illustrate the events shown in FIG. 4, the first six events will be briefly described. The first two events are non-note events, each having a delta time of “0x00” (hexadecimal) preceding it.

The third event is a note-on event having a delta time of “0x00” preceding it.

The byte representation for this event is “90 3C 64”, wherein the “3C” byte represents a pitch of the note being played and the “64” byte represents a volume of the note. By looking at the delta time 52 for the following event, which is “0x78”, we can determine that the event period for this event is equal to “0x78”, meaning that this is a quarter note.

The fourth event is a note-off event having a delta time of “0x78” preceding it. The byte representation for this event is “90 3C 00”, meaning that the volume of the previous note has now been set to “00”, which is zero volume.

Since the delta time 52 immediately following this note-off event is equal to “0x00”, this event has a period of 0.

The fifth event is a note-on event having a delta time of “0x00” preceding it.

The following delta time 52 is “0x78”, making the fifth event another quarter note. In fact, the fifth event plays the same note as the previous note immediately after the previous note has stopped playing.

The sixth event is a note-off event having a delta time of “0x78” preceding it.

The sixth event terminates the note that was begun in the fifth event.

Therefore, so far a total of two notes have been played, with each note having the same pitch and same duration. This is equal to playing the first two notes shown in FIG. 2.

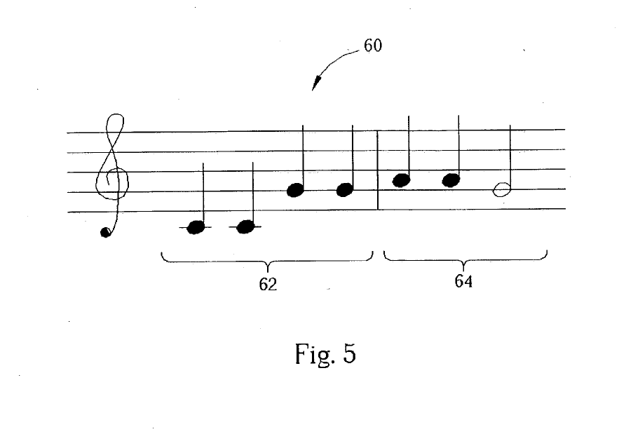

Please refer to FIG. 5. FIG. 5 is a diagram illustrating the main melody 60 of FIG. 2 being divided into measures. Since 4/4 time is the most popular timing for songs used in electronic devices, 4/4 time will be used to break the main melody 60 into a first measure 62 and a second measure 64. The first measure 62 contains four quarter notes and the second measure 64 contains two quarter notes and a half note.

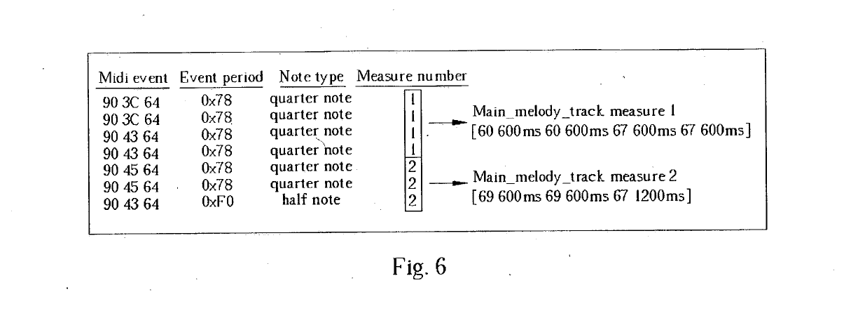

Please refer to FIG. 6. FIG. 6 is a chart of an event buffer showing all of the note-on events shown in FIG. 4. After the user creates the main melody 60, the each note will be added to an event buffer. Each note-on event is stored along with its event period, and the measure that the note is placed in. For example, the first note has a tone of “3C”, which is converted into “60”in decimal. The event period for the first note is “0x78”, which is the same as 600 ms. The event buffer for the first measure will hold four quarter notes and the event buffer for the second measure will hold two quarter notes and one half note.

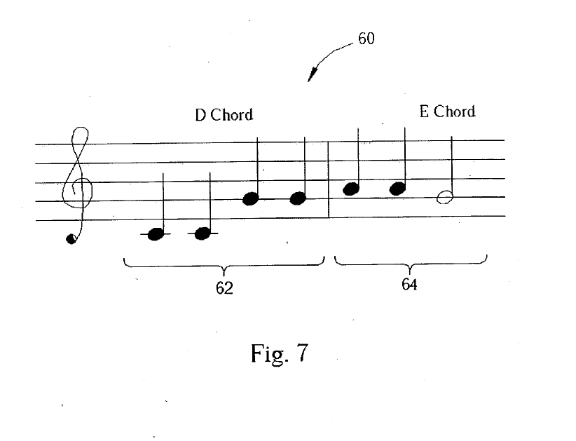

Once the main melody 60 has been divided into measures and written to a track of the MIDI file 30 (in this case, the second track 38), the user is prompted to enter a desired key of the accompaniment tracks for each measure of the main melody 60. If there was a key change in the main melody-60, the key of the accompaniment could easily be changed by specifying a different key for those corresponding measures of the accompaniment. Please refer to FIG. 7. FIG. 7 illustrates assigning keys to measures of the main melody 60 for changing a key of the accompaniment. As the example in FIG. 7 shows, the first measure 62 is assigned an accompaniment key of D, and the second measure 64 is assigned an accompaniment key of E.

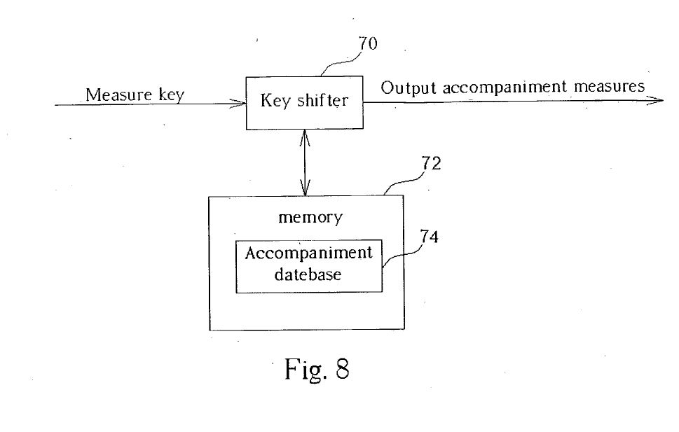

In addition to specifying the key of the accompaniment corresponding to each measure of the main melody 60, the user is also asked to select a style of music such as jazz, dance, etc. Based on the style selection made by the user, accompaniment measures will be retrieved from a database. For simplicity, the database only stores accompaniment measures in the key of C. Any other accompaniment keys will be generated by shifting from the key of C. Please refer to FIG. 8. FIG. 8 illustrates shifting a key of the accompaniment according to the present invention. An accompaniment database 74 stored in a memory 72 contains accompaniment measures for each available style of accompaniment music, and feeds these accompaniment measures to a key shifter 70. The key shifter 70 is a device used to shift a key of the accompaniment music based on a measure key input to the key shifter 70. For instance, to change a key of the accompaniment from C to D, an increase of two half steps is required. Therefore, a value of “2” could be added to the pitch of all notes in the accompaniment measures retrieved from the database.

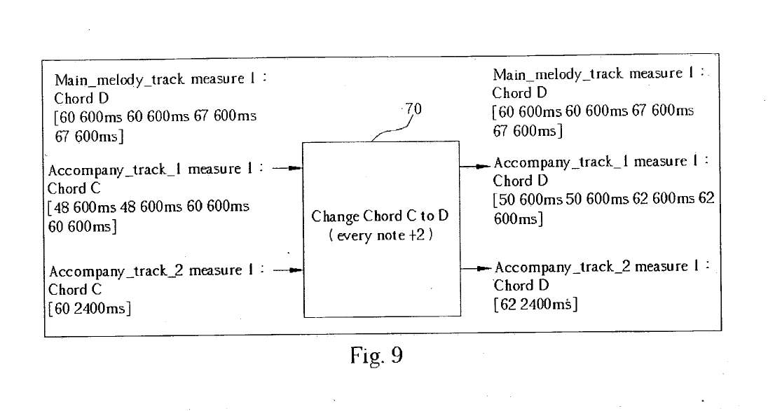

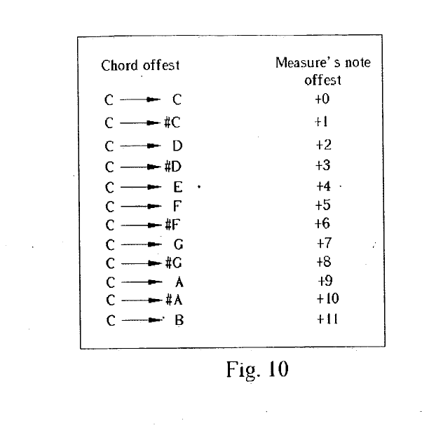

Please refer to FIG. 9. FIG. 9 is a diagram of shifting the key of accompaniment tracks according to the present invention. The first measure 62 of the main melody 60 is shown as having a key of D selected for the accompaniment chord therefore the accompaniment needs to be shifted from the key of C to the key of D. A value of “2” is then added to the pitch of each note in the accompaniment tracks. Please refer to FIG. 10. FIG. 10 is a chart illustrating the offsets of different keys from the key of C. To go from the key of C to the key of A, for example, a value of “9” could be added to the pitch of each note or a value of “3” could be subtracted from the pitch of each note, depending on the desired octave.

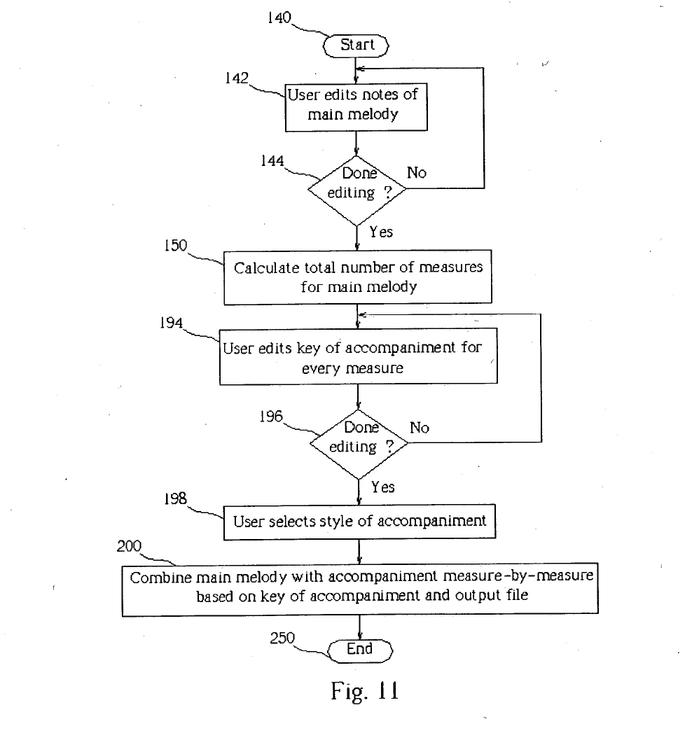

Please refer to FIG. 11. FIG. 11 is a flowchart illustrating creating the MIDI file 30 according to the present invention method. Steps contained in the flowchart will be explained below.

Step 140: Start;

Step 142: The user edits the notes of the main melody 60 by selecting a duration and pitch of each note;

Step 144: Determine if the user is finished editing the main melody 60; if so, go to step 150; if not, go back to step 142;

Step 150: Calculate the total number of measures of the main melody 60; go to step 194;

Step 194: The user edits the accompaniment key corresponding to each measure of the main melody 60;

Step 196: Determine if the user is finished editing the accompaniment keys; if so, go to step 198; if not, go back to step 194;

Step 198: The user selects the style of music for the accompaniment such as jazz, dance, etc;

Step 200: Combine the main melody 60 with the accompaniment measure-by-measure based on the selected style and key of the accompaniment, and output the MIDI file 30; go to step 250; and

Step 250: End.

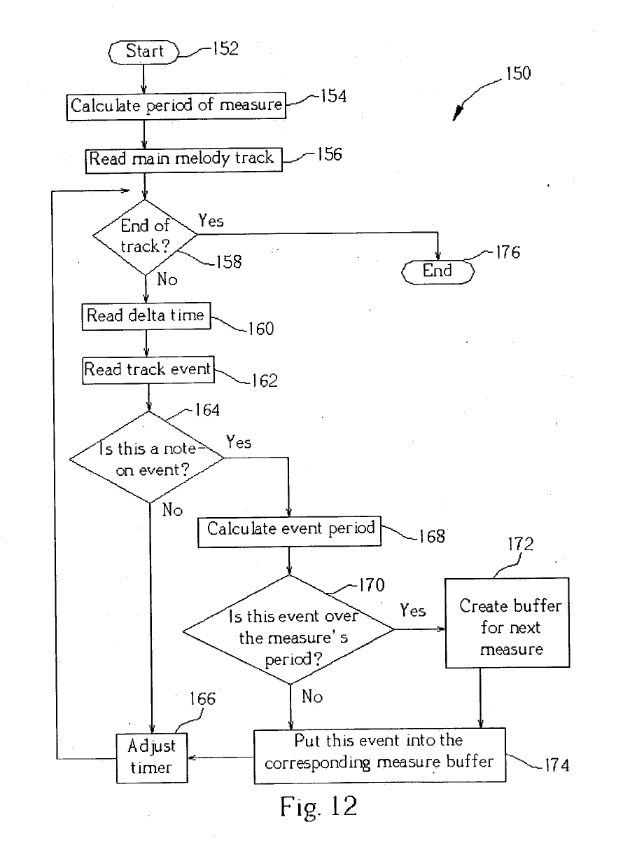

Please refer to FIG. 12. FIG. 12 is a flowchart further illustrating calculating the total number of measures in the main melody 60 (step 150 in the flowchart of FIG. 11) according to the present invention method. Steps contained in the flowchart will be explained below.

Step 152: Start;

Step 154: Calculate the total period of a measure based on the period of a quarter note;

Step 156: Read the main melody track;

Step 158: Determine if the end of the main melody track has been reached; if so, go to step 176; if not, go to step 160;

Step 160: Read next delta time;

Step 162: Read next track event;

Step 164: Determine if this event is a note-on event; if so, go to step 168; if not, go to step 166;

Step 166: Adjust the timer by adding up all previous delta times; go to step 158;

Step 168: Calculate the period of this event;

Step 170: Determine if this event is over the period of the current measure; if so, go to step 172; if not, go to step 174;

Step 172: Create a buffer for the next measure;

Step 174: Put this event into the corresponding measure buffer; go to step 166; and

Step 176: End.

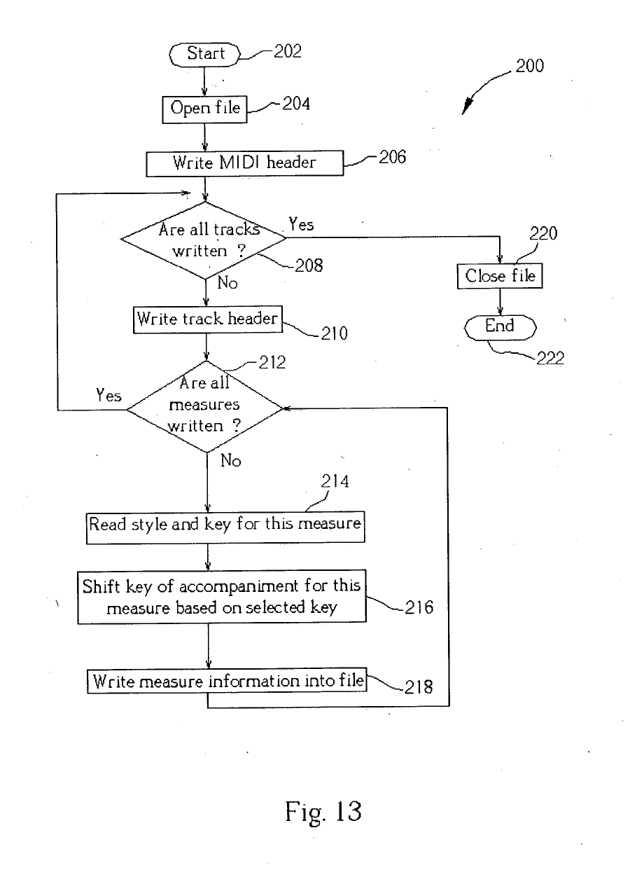

Please refer to FIG. 13. FIG. 13 is a flowchart further illustrating combining the main melody. 60 with accompaniment tracks (step 200 in the flowchart of FIG. 11) according to the present invention method. Steps contained in the flowchart will be explained below.

Step 202: Start;

Step 204: Open the MIDI file 30 for writing;

Step 206: Write the midi file header 32;

Step 208: Determine if all tracks have been written to the MIDI file 30; if yes, go to step 220; if not, go to step 210;

Step 210: Write the track header for the current track;

Step 212: Determine if all data for all measures has been written for the current track; if so, go back to step 208; if not, go to step 214;

Step 214: Read the style and key for the accompaniment corresponding to the current measure;

Step 216: Shift the key of the accompaniment for this measure based on the selected key;

Step 218: Write the data for this measure into the MIDI file 30; go back to step 212;

Step 220: Close the file to finish the writing process; and

Step 222: End.

Compared to the prior art, the present invention method allows users to create a MIDI file by simply editing a main melody, selecting an accompaniment key for each measure of the main melody, and selecting a style of the accompaniment. This improved process for creating MIDI files allows users to create their own songs quickly and easily. Moreover, even users with no knowledge of music theory can still create sophisticated music files.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of creating a music file comprising a plurality of tracks to be played simultaneously when the music file is played, the method comprising:
creating a main melody track by selecting a respective pitch and duration of a plurality of notes;
selecting a style of accompaniment music;
retrieving accompaniment tracks for the selected style of accompaniment music from a memory; and
combining the main melody track and the accompaniment tracks to create the music file.

2. The method of claim 1 further comprising selecting a key of the accompaniment music.

3. The method of claim 1 wherein the accompaniment tracks are retrieved from a database stored in the memory according to the selected style of accompaniment music.

4. The method of claim 1 further comprising dividing the main melody track into a plurality of measures according to the duration of the notes.

5. The method of claim 4 further comprising selecting a key of the accompaniment music for each measure of the main melody track.

6. The method of claim 5 wherein the key of each measure of the accompaniment tracks is shifted to match the selected key.

7. The method of claim 1 wherein the music file is a Musical Instrument Digital Interface (MIDI) file.

8. A music editing device for implementing the method of claim 1.

9. A computing device for creating a music file comprising a plurality of tracks to be played simultaneously when the music file is played, the computing device comprising: a plurality of input keys used for inputting a main melody track by selecting a respective pitch and duration of a plurality of notes and for selecting a style of accompaniment music;
a memory for storing accompaniment tracks of various styles of accompaniment music; and
a processor for combining the main melody track and the selected style of accompaniment tracks to create the music file.

10. The computing device of claim 9 wherein the music file is a Musical Instrument Digital Interface (MIDI) file.
